(19) United States
(12) Patent Application Publication
(10) Pub. No.: US 2009/0323857 A1
(43) Pub. Date: Dec. 31, 2009

(54) CONFIGURABLE SUB-BAND FILTERING TO REDUCE PEAK-TO-AVERAGE POWER RATIO OF OFDM SIGNALS OR THE LIKE

(76) Inventors: Chitranjan K. Singh, San Diego, CA (US); Masoud Sajadieh, Fremont, CA (US)

Correspondence Address: COOL PATENT, P.C.;c/o CPA Global, P.O. BOX 52050, MINNEAPOLIS, MN, 55402, US

(21) Appl. No.: 12/165,142

(22) Filed: Jun. 30, 2008

(51) Int. Cl. H04L 25/49

(52) U.S. Cl. 375/297

(57) ABSTRACT

Briefly, in accordance with one or more embodiments, a reduction in peak-to-average power ratio (PAPR) in an OFDM signal may be achieved by clipping the OFDM signal, extracting the clipping noise, filtering the clipping noise, and then constructing the clipped OFDM signal with the filtered clipping noise.

### BACKGROUND

Orthogonal Frequency Division Multiplexing (OFDM) is a multi-carrier transmission technique that divides the available bandwidth into N orthogonal subcarriers and transmits N complex symbols by mapping them onto the respective subcarriers. The OFDM symbol is generated by first converting the set X of complex data points into set x of time-domain data points using an N-point inverse fast Fourier Transform (IFFT) using the following equation:

$$X = {[ \begin{matrix}{X}_{0} & … & {X}_{N - 1}\end{matrix} ]}^{T} {}^{IFFT} x = {[ \begin{matrix}{x}_{0} & … & {x}_{N - 1}\end{matrix} ]}^{T}$$

$$x [ n ] = \frac{1}{\sqrt{N}} {\sum }_{k = 0}^{N - 1} {X}_{k} {e}^{j 2 π kn / N} \text{;} n = 0 , … , N - 1.$$

When N is large, real and imaginary components of each point x[n] tends to a random variable with Gaussian distribution. This in effect leads to high peak-to-average power ratio (PAPR), defined by the following equation for an OFDM symbol:

$$P A P R ( x ) = \frac{{max}_{0 \leq n \leq N - 1} {\vert x [ n ] \vert}^{2}}{E \{ {\vert x [ n ] \vert}^{2} \}} .$$

The high PAPR is a major disadvantage of OFDM systems, which have become popular in most of the current and future broadband wireless systems. The clipping by a power amplifier causes nonlinear output, degrading adjacent channels through spectral re-growth. To avoid peak clipping, the analog RF transmitter requires an expensive high-power amplifier (HPA) with large dynamic range linearity. The wide dynamic range support for the occasional peaks drastically reduces the power efficiency of a HPA. For example, consider a class-A amplifier which has quasi-linear characteristic up to its saturation output power and hence is widely used for OFDM signals. The theoretical peak power amplifier (PA) efficiency is 50% but decreases inversely with PAPR and drops to around 5% when PAPR is set to 10 dB. The average efficiency is even lower than this given the highly dynamic nature of the OFDM signal, which is another manifestation of high PAPR values. As a result, class-A power amplifiers experience a doubling of peak efficiency with every 3 dB of PAPR reduction.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a block diagram of a transmitter capable of performing clipping and filtering of an OFDM signal in accordance with one or more embodiments;

FIG. 2 is a block diagram of a hard-clipping circuit in accordance with one or more embodiments;

FIG. 3 is a block diagram of one implementation of an FIR filter in accordance with one or more embodiments;

FIG. 4 is a block diagram of another implementation of an FIR filter in accordance with one or more embodiments;

FIG. 5 is a flow diagram of a method to obtain a reduced PAPR in an OFDM transmitter in accordance with one or more embodiments; and

FIG. 6 is a block diagram of a wireless network in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

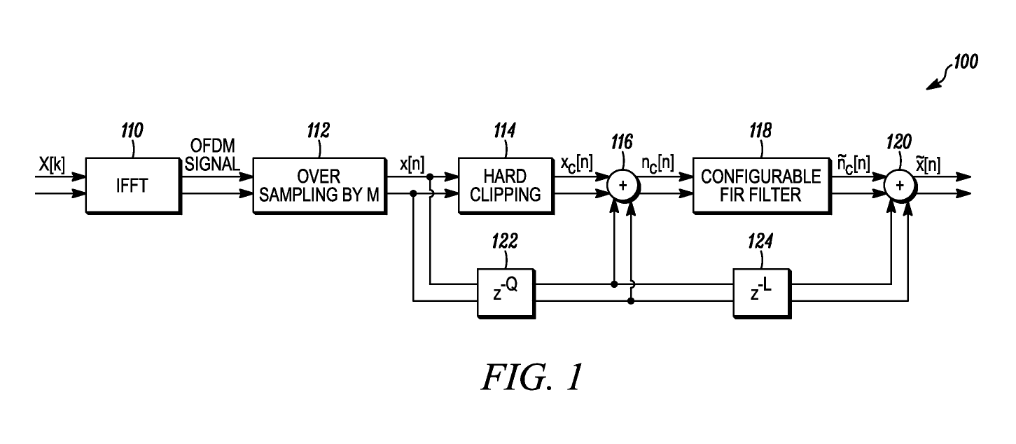

Referring now to FIG. 1, a block diagram of a transmitter capable of performing clipping and filtering of an orthogonal frequency-division multiplexing (OFDM) signal in accordance with one or more embodiments will be discussed. Transmitter 100 of FIG. 1 is capable of reducing the peak-to-average power ratio (PAPR) of an OFDM signal by clipping and restoring the original signal by filtering the clipped noise from the relevant frequency band. As shown in FIG. 1, the double arrow lines indicate complex in-phase and quadrature (I/Q) signals processed by transmitter 100. For purposes of discussion, transmitter 100 transmits an OFDM signal having a bandwidth of B and sampled at frequency Fₛ. Three performance metrics may be considered, namely power spectral density (PSD) margin relative to a given mask, transmit Error Vector Magnitude (EVM), and effective PAPR as defined at complementary CDF (CCDF) of 0.01, meaning the PAPR of an OFDM symbol may be greater than the effective PAPR for only about 1% of the time. Furthermore, two cost metrics may be considered, namely complexity in terms of number of multipliers and latency in terms of number of clock cycles to implement the proposed technique. In one or more embodiments, the PAPR reduction scheme implemented by transmitter 100 is capable of operating on a strongly clipped OFDM signal which has a relatively poor EVM and extensive spectral regrowth. Transmitter 100 attempts to restore the original signal through selective filtering of clipping noise, wherein in one or more embodiments, spectral regrowth may be suppressed and EVM may be decreased while reducing the effective PAPR of the original signal by about 2-3 dB, although the scope of the claimed subject matter is not limited in these respects.

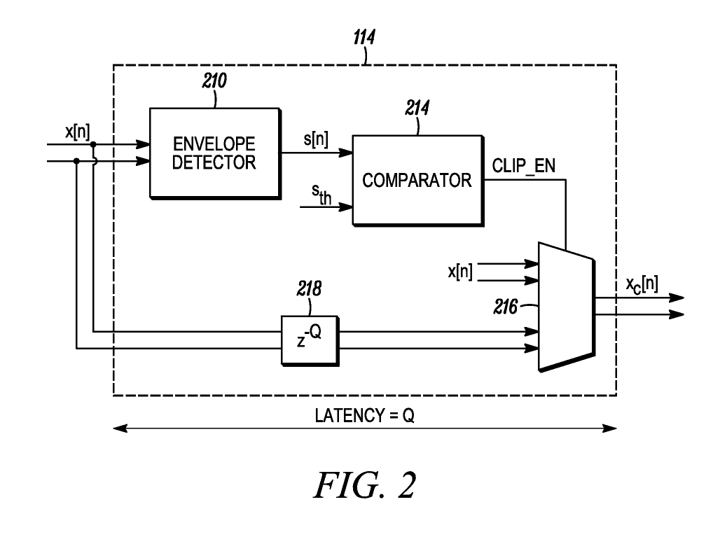

As shown in FIG. 1, the signal to be transmitted X[k] is applied to an inverse fast Fourier transform (IFFT) circuit 110 to generate an OFDM signal to be transmitted. The OFDM signal is oversampled by a value of M by oversampling circuit 112 to produce signal x[n]. The peak of the signal x[n] is reduced by hard-clipping the signal via hard-clipping circuit 114 whenever the magnitude of the signal exceeds a predetermined threshold sₜₕ to result in clipped signal x[n] having a magnitude at or below the predetermined threshold. At this point in transmitter 100 path, clipped signal x_{c}[n] includes clipping noise which comprises higher frequency components as a result of the clipping function. To extract the clipping noise n_{c}[n] from the clipped signal, a delayed version of the original, non-clipped signal x[n] is subtracted from the clipped signal x_{c}[n] via summing element 116 with a delayed version of the original, non-clipped signal x[n]. The delay is introduced by delay element 122 which delays the signal by z^{-Q}. The clipping noise n_{c}[n] is then filtered via configurable finite impulse response (FIR) filter 118 to obtain a filtered version of the clipping noise, ñ_{c}[n]. Then a restoration of the signal to be transmitted is made by combining the filtered clipping noise ñ_{c}[n] with the clipped OFDM signal x_{c}[n] via summing element 120 to result in a signal to be transmitted \tilde{x}[n] by transmitter 100. The resulting signal to be transmitted \tilde{x}[n] may then essentially represent a clipped version of the signal to be transmitted that includes a filtered version of the clipping noise. A suitable hard clipping circuit for clipping the signal to be transmitted is shown in and described with respect to FIG. 2, below.

Referring now to FIG. 2, a block diagram of a hard-clipping circuit in accordance with one or more embodiments will be discussed. As shown in FIG. 2, the magnitude of the complex signal x[n] may be computed by envelope detector circuit 210 to result in signal envelope s[n], followed by comparison of the signal envelope s[n] with the threshold sₜₕ via comparator circuit 214 to arrive at the clipping envelope clip_en. The clipping envelope clip_en is then used as a control signal for multiplexer 216 which multiplexes the complex signal x[n] with a delayed version of the complex signal x[n]. The amount of delay, or latency, may be obtained via delay circuit 218 which delays the signal by z^{-Q}. The resulting output of multiplexer 216 is the output of hard clipping circuit 114 which outputs the clipped OFDM signal x_{c}[n]. In general, as an alternative to performing a direct computation of signal envelope s[n], the approximate envelope may be computed using the following expression:

$$Approximate Envelope \text{:} s [ n ] = max ( \vert {x}_{I} \vert , \vert {x}_{Q} \vert ) + ( \frac{1}{4} ) min ( \vert {x}_{I} \vert , \vert {x}_{Q} \vert )$$

In one or more embodiments, using approximate envelope may have the same, or nearly the same, PSD margin and/or EVM, and effective PAPR may be slightly higher, by about less than 0.2 dB, than calculating an exact envelope. Furthermore, using an approximate envelope may also result in a substantial reduction in circuit complexity of hard clipping circuit 114, although the scope of the claimed subject matter is not limited in these respects.

In general, clipping via hard clipping circuit 114 may introduce spectral regrowth in the form of out-of-band transmit noise in the adjacent channel and beyond. Such clipping noise may be removed from the frequency band of interest (between fᵢ and fⱼ, where f₁≦fᵢ_{₂}f₂ⱼ≦f₂; f₁=B/2, f₂=Fₛ/2) using configurable filter 118 of FIG. 1. The clipping noise is computed by simply subtracting the unclipped OFDM signal x[n] from the clipped signal, x_{c}[n]. The final signal to be transmitted may then be constructed by adding the filtered clipping noise with the OFDM signal. The final restored signal \tilde{x}[n] may exhibit a PAPR lower than that of the original signal x[n]. Due to the filtering operation, there may be a peak regrowth, which comprises reappearance of peaks exceeding the threshold, in the restored signal with respect to the clipped signal, x_{c}[n], which has a peak of sₜₕ. To reduce such an effect of peak regrowth and/or to obtain a sufficient reduction in PAPR, the clipping noise n_{c}[n] may be scaled up by a noise scaling factor (NSF) via an optional scaling circuit (not shown) before passing through configurable FIR filter 118. In one or more embodiments, the scaling factor may be about 1.3≦NSF≦1.7. By utilizing such a technique, PAPR may be reduced to fall in the range of about 2 dB to 3.2 dB with respect to the original OFDM signal x[n] with a relatively small degradation in EVM and/or BER performance and/or also utilizing little complexity in transmitter 100, although the scope of the claimed subject matter is not limited in these respects.

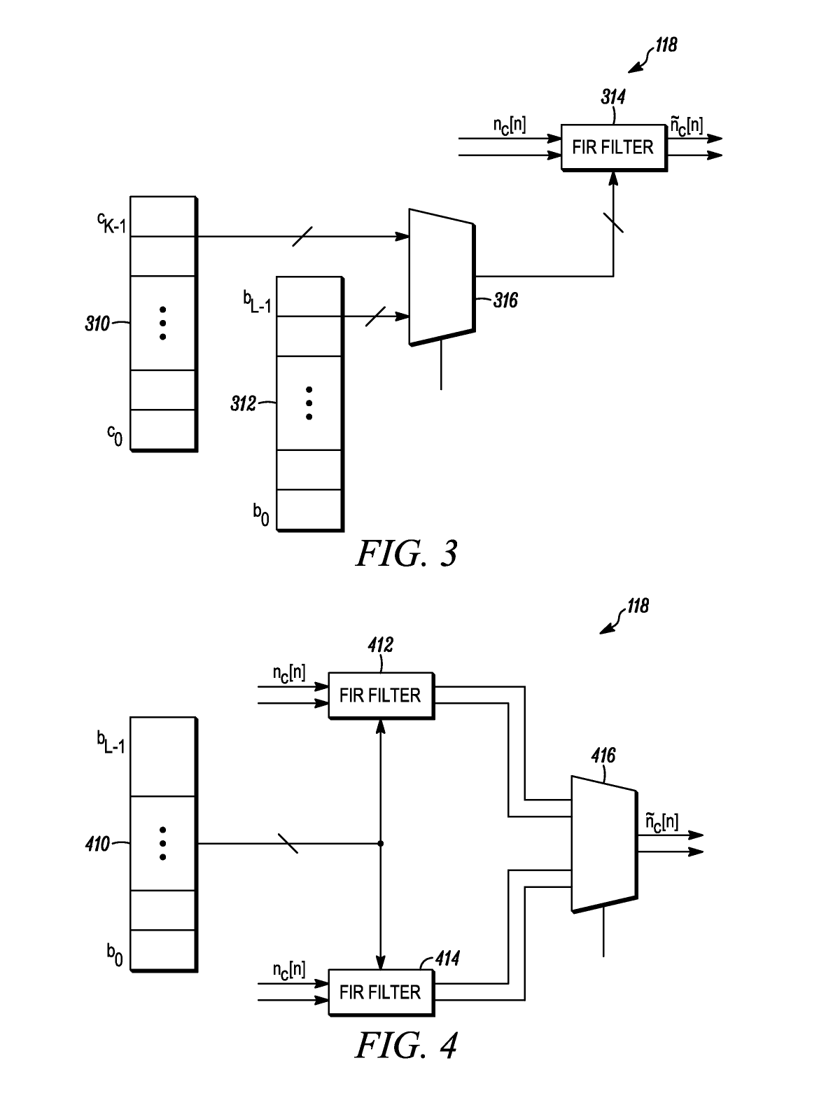

In one or more embodiments, the filtering operation is performed on the clipping noise itself and not on the clipped signal. Since occurrence of a higher PAPR event has relatively low probability and, once occurred, the clipping noise is non-zero only for a relatively small duration, as a result such an approach may result in lower power consumption of transmitter 100, as multipliers and adders in configurable FIR filter 118 may be active only for a relatively small duration. Example filter arrangements for configurable filter 118 are shown in and described with respect to FIG. 3 and FIG. 4, below.

Referring now to FIG. 3 and FIG. 4, block diagrams of implementations of an FIR filter in accordance with one or more embodiments will be discussed. As shown in FIG. 3, configurable FIR filter 118 may comprise two separate memories, memory 310 and memory 312, for storing the filter coefficients in which the tap coefficients for FIR filter block 314 may be stored. In order to configure filter 118 to a desired filter response, tap coefficients in memory 310 and/or memory 312 may be updated based on the type and/or parameters of the filter to be implemented. The type of filter may then be selected via multiplexer 316 to select the appropriate memory 310 or 312. In the embodiment shown in FIG. 4, a single memory 410 may store the filter tap coefficients, and two filter blocks, filter block 412 and filter block 414 may be implemented separately. The desired filter block may then be selected via multiplexer 416. In one or more embodiments, utilization of reconfigurable FIR filter 118 such as shown in FIG. 3 and/or FIG. 4 gives flexibility of removing the noise from a frequency band that is relevant to a particular application of transmitter 100. For example, in one or more embodiments configurable FIR filter 118 may be optimized for a relevant band where noise may be significant, where the effect of noise in other bands may be insignificant, thereby allow for a lower filter complexity by optimizing only for the relevant band. Furthermore, from the arrangement of transmitter 100 of FIG. 1, in one or more embodiments configurable FIR filter 118 may operate only on the clipping noise and not the entire clipped-signal. Such an arrangement of transmitter 100 may result in a relatively larger savings in power consumption. In one or more embodiments, configurable FIR filter 118 may become active only if the signal peak exceeds the threshold, as opposed to be active all of the time, thereby also resulting in reduced power consumption. However, these are merely examples of transmitter 100 and configurable FIR filter 118, and the scope of the claimed subject matter is not limited in these respects.

In one or more embodiments, configurable FIR filter 118 may be selected to achieve a desired performance of transmitter 100. To describe configurable FIR filter, an appropriate filter length L may be selected. Although configurable FIR filter 118 can be reconfigured for filtering out the clipping noise from any frequency band, fᵢ-fⱼ, example results for the following four example cases may be described. The four example cases are summarized in Table 1, below, and the magnitude spectrum for four example filters are as follows: Case (a) filter out most of the clipping noise from the out-of band channel; Case (b) filter out most of the clipping noise from the adjacent channel; case (c) filter out most of the clipping noise from adjacent channel and some of the clipping noise from out-of band channel; and Case (d) filter out most of the clipping noise from all bands. Filter 1: Fc=11 MHz, Fs=160 MHz, L=13; Filter 2: Fc1=10 MHz, Fc2=35 MHz, Fs=160 MHz, L=30; Filter 3: Fc1=10 MHz, MHz, Fs=160 MHz, L=40; Filter 4: Fc1=10 MHz, Fc2=78 MHz, Fs=160 MHz, L=40. A scaling factor NSF was also selected for a corresponding filter.

TABLE 1
Selection of a desired filter response to filter clipping noise

| | | | Effective | Reduction in |
|---|---|---|---|---|
| | FIR | | PAPR | effective PAPR |
| | length | EVM | (dB) | wrt original |
| | (L) | (dB) | (CCDF = 0.01) | signal (dB) |
| Original | N/A | unlimited | 9.8 | N/A |
| Signal | | | | |
| Hard-Clipped | N/A | −30.3 | 6 | N/A |
| at 6 dB | | | | |
| Case(a): | 13 | −30.3 | 6.7 | 3.1 |
| Restoration | | | | |
| by Filter 1 | | | | |
| Case(b): | 30 | −30.9 | 8.2 | 1.6 |
| Restoration | | | | |
| by Filter 2 | | | | |
| Case(b): | 30 | −28.8 | 6.7 | 3.1 |
| Noise scaled | | | | |
| by NSF = 1.3 | | | | |
| Case(c): | 40 | −30.8 | 8 | 1.8 |
| Restoration | | | | |
| by Filter 3 | | | | |
| Case(c): | 40 | −28.6 | 7.5 | 2.3 |
| Noise scaled | | | | |
| by NSF = 1.3 | | | | |
| Case(d) | 40 | −31.3 | 8.3 | 1.5 |
| Restoration | | | | |
| by Filter 4 | | | | |
| Case(d): | 40 | −28.1 | 7.5 | 2.3 |
| Noise scaled | | | | |
| by NSF = 1.5 | | | | |

As can be seen in Table 1, a reduction in effective PAPR of about 3 dB or more with respect to the original signal may be obtained via appropriate selection of the type of filter for configurable FIR filter 118 and/or an appropriate scaling factor NSF. However, the results in Table 1 are merely example results, and other results may be obtained using different types of filters, filter parameters, and/or scaling factors, and the scope of the claimed subject matter is not limited in these respects.

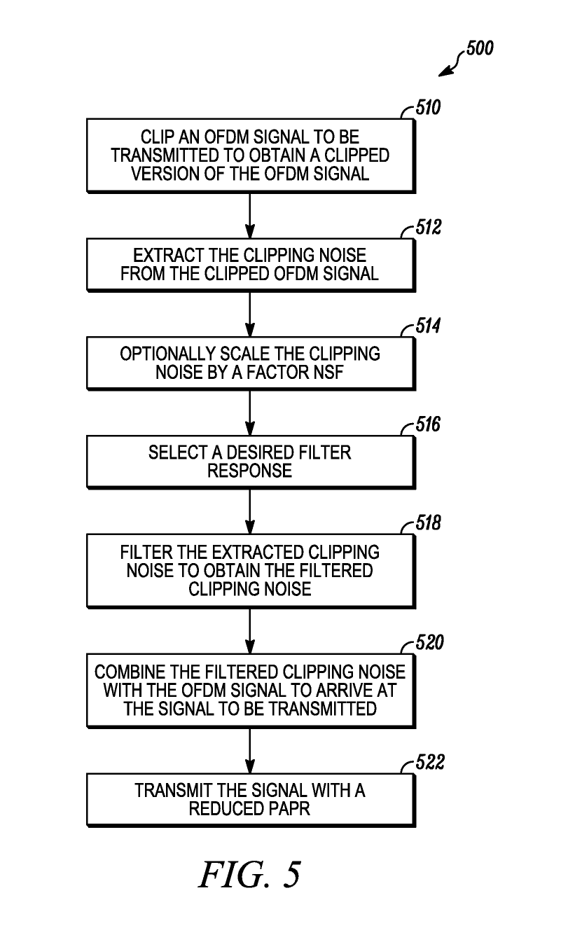

Referring now to FIG. 5, a flow diagram of a method to obtain a reduced PAPR in an OFDM transmitter in accordance with one or more embodiments will be discussed. Method 500 may include fewer or greater blocks, and/or the blocks may be arranged in different orders, than shown in FIG. 5, and the scope of the claimed subject matter is not limited in these respects. In one or more embodiments, method 500 may be implemented by transmitter 100 of FIG. 1 to transmit an OFDM signal having a reduced PAPR value. At block 510, a OFDM signal may be clipped to obtain a clipped version of the OFDM signal. Since a hard clipped signal may result in out-of-band frequency components having significant magnitudes as clipping noise, the clipping noise may be filtered to reduce and/or eliminate such out-of-band frequency components. To accomplish such filtering, the clipping noise may be extracted at block 514 from the clipped OFDM signal. The extracted clipping noise optionally may be scaled at block 514 by a noise scaling factor (NSF). A desired filter response may be selected at block 516 to obtain a desired filter response, for example by selecting an appropriate filter length, filter cut-off frequencies, and/or filter sampling rate. The extracted clipping noise may be filtered at block 518 with such an appropriate configuration of configurable FIR filter 118 to obtain the filtered clipping noise. The signal to be transmitted may then be constructed at block 520 by combining the filtered clipping noise with the clipped OFDM signal to arrive at the signal to be transmitted. Such a constructed signal may represent a clipped version of the OFDM signal with filtered clipping noise. The constructed signal may then be transmitted at block 522 with a reduced PAPR.

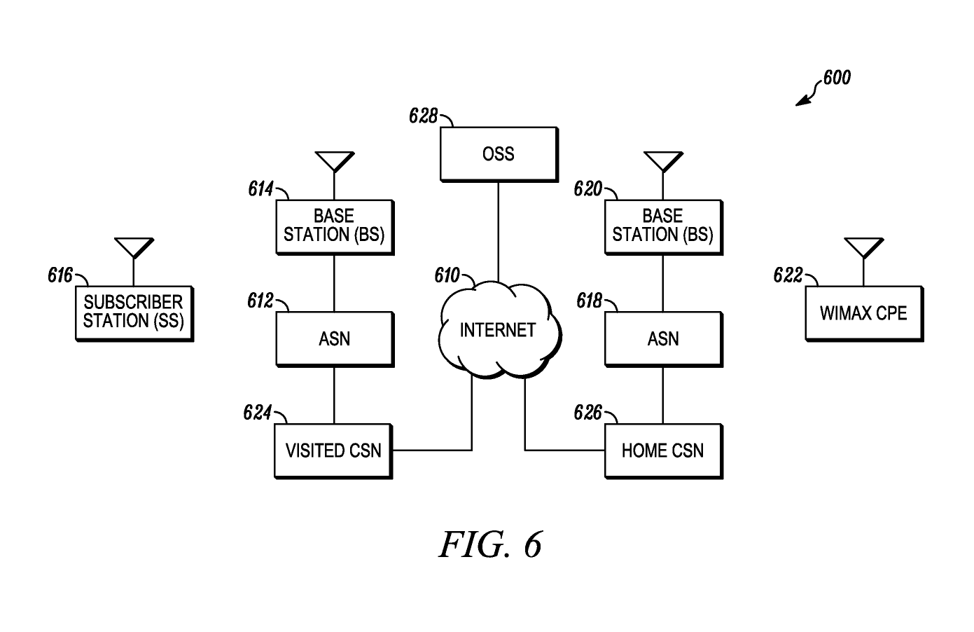

Referring now to FIG. 6, a block diagram of a wireless network in accordance with one or more embodiments will be discussed. One or more of the elements of wireless network 600 may utilize transmitter 100 of FIG. 1, for example base station 614, subscriber station 616, base station 620, and/or customer premises equipment 622. As shown in FIG. 6, network 600 may be an internet protocol (IP) type network comprising an internet 610 type network or the like that is capable of supporting mobile wireless access and/or fixed wireless access to internet 610. In one or more embodiments, network 600 may be in compliance with a Worldwide Interoperability for Microwave Access (WiMAX) standard or future generations of WiMAX, and in one particular embodiment may be in compliance with an Institute for Electrical and Electronics Engineers 802.16e standard (IEEE 802.16e), or an IEEE 802.11a/b/g/n standard, and so on. In one or more alternative embodiments network 600 may be in compliance with a Third Generation Partnership Project Long Term Evolution (3GPP LTE) or a 3GPP2 Air Interface Evolution (3GPP2 AIE) standard. In general, network 600 may comprise any type of orthogonal frequency division multiple access (OFDMA) based wireless network, for example WiMAX compliant network, Wi-Fi Alliance Compliant Network, a digital subscriber line (DSL) type network, an asymmetric digital subscriber line (ADSL) type network, an Ultra-Wideband (UWB) compliant network, a Wireless Universal Serial Bus (USB) compliant network, a 4^{th} Generation (4G) type network, and so on, and the scope of the claimed subject matter is not limited in these respects. As an example of mobile wireless access, access service network (ASN) 612 is capable of coupling with base station (BS) 614 to provide wireless communication between subscriber station (SS) 616 and internet 610. Subscriber station 616 may comprise a mobile type device or information handling system capable of wirelessly communicating via network 600, for example a notebook type computer, a cellular telephone, a personal digital assistant, or the like. ASN 612 may implement profiles that are capable of defining the mapping of network functions to one or more physical entities on network 600. Base station 614 may comprise radio equipment to provide radio-frequency (RF) communication with subscriber station 616, and may comprise, for example, the physical layer (PHY) and media access control (MAC) layer equipment in compliance with an IEEE 802.16e type standard. Base station 614 may further comprise an IP backplane to couple to internet 610 via ASN 612, although the scope of the claimed subject matter is not limited in these respects.

Network 600 may further comprise a visited connectivity service network (CSN) 624 capable of providing one or more network functions including but not limited to proxy and/or relay type functions, for example authentication, authorization and accounting (AAA) functions, dynamic host configuration protocol (DHCP) functions, or domain name service controls or the like, domain gateways such as public switched telephone network (PSTN) gateways or voice over internet protocol (VOIP) gateways, and/or internet protocol (IP) type server functions, or the like. However, these are merely example of the types of functions that are capable of being provided by visited CSN or home CSN 626, and the scope of the claimed subject matter is not limited in these respects. Visited CSN 624 may be referred to as a visited CSN in the case for example where visited CSN 624 is not part of the regular service provider of subscriber station 616, for example where subscriber station 116 is roaming away from its home CSN such as home CSN 626, or for example where network 600 is part of the regular service provider of subscriber station but where network 600 may be in another location or state that is not the main or home location of subscriber station 616. In a fixed wireless arrangement, WiMAX type customer premises equipment (CPE) 622 may be located in a home or business to provide home or business customer broadband access to internet 610 via base station 620, ASN 618, and home CSN 626 in a manner similar to access by subscriber station 616 via base station 614, ASN 612, and visited CSN 624, a difference being that WiMAX CPE 622 is generally disposed in a stationary location, although it may be moved to different locations as needed, whereas subscriber station may be utilized at one or more locations if subscriber station 616 is within range of base station 614 for example. It should be noted that CPE 622 need not necessarily comprise a WiMAX terminal, and may comprise other types of terminals or devices compliant with one or more standards or protocols for example as discussed herein, and in general may comprise a fixed or a mobile device. In accordance with one or more embodiments, operation support system (OSS) 628 may be part of network 600 to provide management functions for network 600 and to provide interfaces between functional entities of network 600. Network 600 of FIG. 6 is merely one type of wireless network showing a certain number of the components of network 600, however the scope of the claimed subject matter is not limited in these respects.

Although the claimed subject matter has been described with a certain degree of particularity, it should be recognized that elements thereof may be altered by persons skilled in the art without departing from the spirit and/or scope of claimed subject matter. It is believed that the subject matter pertaining to configurable sub-band filtering to reduce peak-to-average power ratio of OFDM signals or the like and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. A method, comprising:
clipping an orthogonal frequency division multiplexing (OFDM) signal to be transmitted;
extracting clipping noise from the clipped OFDM signal;
filtering the clipping noise; and
combining the filtered clipping noise with the clipped OFDM signal to arrive at a clipped version of the OFDM signal having filtered clipping noise to arrive at a transmit signal; and
transmitting the transmit signal with a reduced peak-to-average power ratio.

2. A method as claimed in claim 1, further comprising scaling the clipping noise prior to said filtering.

3. A method as claimed in claim 1, further comprising selecting a desired filter response to be implemented by said filtering.

4. A method as claimed in claim 1, wherein said clipping of the OFDM signal occurs if the OFDM signal has a magnitude greater than a threshold value.

5. A method as claimed in claim 1, wherein said clipping of the OFDM signal comprises obtaining an estimate of an envelope of the OFDM signal via an envelope detector.

6. A method as claimed in claim 1, further comprising scaling the clipping noise prior to said filtering with a scaling factor selected to reduce peak regrowth in the filter clipping noise due to said filtering.

7. A method as claimed in claim 1, further comprising scaling the clipping noise after said filtering.

8. An apparatus, comprising:
a hard clipping circuit to clip an orthogonal frequency division multiplexing (OFDM) signal to be transmitted;
a first summing element and a first delay element to subtract a delayed version of the OFDM signal from the clipped OFDM signal to obtain clipping noise;
a filter to filter the clipping noise; and
a second summing element and a second delay element to combine the filtered clipping noise with the clipped OFDM signal to arrive at a clipped version of the OFDM signal having filtered clipping noise to arrive at a transmit signal having a reduced peak-to-average power ratio.

9. An apparatus as claimed in claim 8, further comprising a scaling circuit to scale the clipping noise prior to said filtering the clipping noise with the filter.

10. An apparatus as claimed in claim 8, the filter comprising a configurable filter to allow selection of a desired filter response for the filter.

11. An apparatus as claimed in claim 8, wherein the hard clipping circuit is capable of clipping the OFDM signal occurs if the OFDM signal has a magnitude greater than a threshold value.

12. An apparatus as claimed in claim 8, wherein the hard clipping circuit comprises an envelope detector to obtain an estimate of an envelope of the OFDM signal.

13. An apparatus as claimed in claim 8, further comprising a scaling circuit to scale the clipping noise prior to said filtering with a scaling factor selected to reduce peak regrowth in the filter clipping noise due to filtering by the filter.

14. An apparatus as claimed in claim 8, further comprising a scaling circuit to scale the clipping noise after filtering by the filter.

15. An apparatus as claimed in claim 8, wherein the filter comprises:
a finite impulse response (FIR) filter block;
a first memory to store a set of filter parameters to implement a first filter response for the FIR filter block;
a second memory to store a set of filter parameters to implement a second filter response for the FIR filter block;
wherein the filter exhibits a filter response based on a selection of the first filter response in the first memory or the second filter response in the second memory.

16. An apparatus as claimed in claim 8, wherein the filter comprises:
a first finite impulse response (FIR) filter block to implement a first filter response;
a second finite impulse response (FIR) filter block to implement a second filter response; and
a memory to store a set of filter parameters for the first FIR filter block or the second FIR filter block;
wherein the filter exhibits a filter response based on a selection of the first FIR filter block or the second FIR filter block.

17. An apparatus, comprising:
a transmitter and an antenna couple do the antenna;
wherein the transmitter comprises:
a hard clipping circuit to clip an orthogonal frequency division multiplexing (OFDM) signal to be transmitted;
a first summing element and a first delay element to subtract a delayed version of the OFDM signal from the clipped OFDM signal to obtain clipping noise;
a filter to filter the clipping noise; and
a second summing element and a second delay element to combine the filtered clipping noise with the clipped OFDM signal to arrive at a clipped version of the OFDM signal having filtered clipping noise to arrive at a transmit signal having a reduced peak-to-average power ratio.

18. An apparatus as claimed in claim 17, the transmitter further comprising a scaling circuit to scale the clipping noise prior to said filtering the clipping noise with the filter.

19. An apparatus as claimed in claim 17, the filter comprising a configurable filter to allow selection of a desired filter response for the filter.

20. An apparatus as claimed in claim 17, wherein the hard clipping circuit is capable of clipping the OFDM signal occurs if the OFDM signal has a magnitude greater than a threshold value.
